(19) United States
(12) Patent Application Publication
(10) Pub. No.: US 2018/0307419 A1
(43) Pub. Date: Oct. 25, 2018

(54) STORAGE CONTROL APPARATUS AND STORAGE CONTROL METHOD

(71) Applicant: FUJITSU LIMITED, Kawasaki-shi (JP)

(72) Inventors: Naohiro Takeda, Zushi (JP); Yusuke Kurasawa, Nagano (JP); Norihide KUBOTA, Kawasaki (JP); YOSHIHITO KONTA, Kawasaki (JP); Toshio Kikuchi, Sagamihara (JP); Yuji TANAKA, Inagi (JP); Marino Kajiyama, Yokohama (JP); Yusuke Suzuki, Kawasaki (JP); Takeshi WATANABE, Kawasaki (JP); YOSHINARI SHINOZAKI, Kawasaki (JP)

(73) Assignee: FUJITSU LIMITED, Kawasaki-shi (JP)

(21) Appl. No.: 15/949,117

(22) Filed: Apr. 10, 2018

(30) Foreign Application Priority Data
Apr. 20, 2017 (JP) 2017-083953

(51) Int. Cl. G06F 3/06; G06F 12/10; G06F 12/02

(52) U.S. Cl. CPC G06F 3/0616; G06F 12/10; G06F 12/0253; G06F 2212/1036; G06F 3/0652; G06F 3/0679; G06F 2212/1044; G06F 3/0608

(57) ABSTRACT

A storage control apparatus configured to control a storage device including a storage medium with a limited number of writes, includes a memory, and a processor coupled to the memory and configured to record, to the storage medium, address conversion information associating logical addresses by which an information processing apparatus that uses the storage device identifies data with physical addresses indicating positions where the data is stored on the storage medium, and execute garbage collection of the storage medium based on the recorded address conversion information.

### CROSS-REFERENCE TO RELATED APPLICATION

This application is based upon and claims the benefit of priority of the prior Japanese Patent Application No. 2017-83953, filed on Apr. 20, 2017, the entire contents of which are incorporated herein by reference.

### FIELD

The embodiment discussed herein is related to a storage control apparatus and a storage control method.

### BACKGROUND

Recently, the storage media of storage apparatus is shifting from hard disk drives (HDDs) to flash memory such as solid-state drives (SSDs) with faster access speeds. In an SSD, memory cells are not overwritten directly. Instead, data is written after deleting data in units of blocks having a size of 1 megabyte (MB), for example.

For this reason, in the case of updating some of the data within a block, the other data within the block is evacuated, the block is deleted, and then the evacuated data and the updated data are written. For this reason, the process of updating data which is small compared to the size of a block is slow. In addition, SSDs have a limited number of writes. For this reason, in an SSD, it is desirable to avoid updating data which is small compared to the size of a block as much as possible. Accordingly, in the case of updating some of the data within a block, the other data within the block and the updated data are written to a new block.

However, if a new block is used to perform a data update, the physical address where the data is stored changes, and thus the management data (metadata) that associates logical addresses and physical addresses is updated. Also, in a storage apparatus, to reduce the data writing volume, duplicate data blocks are removed, but the management data for deduplication is also updated.

Note that there is technology for an apparatus including multiple SSDs, in which the technology disconnects an SSD for which a wear value indicating a wear state has exceeded a first threshold value, and if there is an SSD whose wear value has exceeded a second threshold value before reaching the first threshold value, the wear value between the SSD that has exceeded the second threshold value and other SSDs is expanded. According to this technology, it is possible to reduce the risk of multiple disk failure, in which multiple SSDs reach end-of-life at the same time.

In addition, there exists technology for flash memory having a memory cell array made up of multiple user regions where data stored and multiple flag regions indicating the states of the user regions, in which the technology references the flag regions to generate and output notification information for issuing an external notification indicating information corresponding to the states of the user regions. According to this technology, the internal state of flash memory may be learned easily outside the flash memory, and whether or not to perform a garbage collection process may be determined.

For examples of technologies of the related art, refer to Japanese Laid-open Patent Publication No. 2016-12287 and International Publication Pamphlet No. WO 2004/077447.

### SUMMARY

According to an aspect of the invention, a storage control apparatus configured to control a storage device including a storage medium with a limited number of writes, includes a memory, and a processor coupled to the memory and configured to record, to the storage medium, address conversion information associating logical addresses by which an information processing apparatus that uses the storage device identifies data with physical addresses indicating positions where the data is stored on the storage medium, and execute garbage collection of the storage medium based on the recorded address conversion information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a storage configuration of a storage apparatus according to an embodiment;

FIG. 2 is a diagram illustrating the format of a RAID unit;

FIGS. 3A to 3C are diagrams illustrating the format of reference metadata;

FIG. 4 is a diagram illustrating the format of logical/physical metadata;

FIG. 5 is a diagram for describing a meta-metadata scheme according to an embodiment;

FIG. 6 is a diagram illustrating the format of a meta-address;

FIG. 7 is a diagram illustrating an exemplary arrangement of RAID units in a drive group;

FIG. 8 is a diagram illustrating the configuration of an information processing system according to an embodiment;

FIG. 9 is a diagram for describing GC polling in pool units;

FIG. 10 is a diagram for describing the appending of valid data;

FIGS. 11A and 11B are diagrams illustrating the format of an RU management table;

FIG. 12 is a diagram for describing compulsory GC;

FIG. 13 is a diagram illustrating relationships among functional units;

FIG. 14 is a flowchart illustrating the flow of GC polling;

FIG. 15 is a flowchart illustrating the flow of a patrol thread process;

FIG. 16A is a first diagram illustrating a sequence of exclusive control between data writing and GC;

FIG. 16B is a second diagram illustrating a sequence of exclusive control between data writing and GC;

FIG. 17A is a diagram illustrating a sequence of GC of a user data unit;

FIG. 17B is a diagram illustrating a sequence of GC of logical/physical metadata; and

FIG. 18 is a diagram illustrating the hardware configuration of a storage control apparatus that executes a storage control program according to an embodiment.

### DESCRIPTION OF EMBODIMENTS

In the case of using a new region to update the management data that associates logical addresses and physical addresses, a region that has become unneeded due to updating may be produced in an SSD.

In one aspect of the present disclosure, an objective is to recover unused regions produced by the updating of management data.

Hereinafter, an embodiment of a storage control apparatus, a storage control method, and a storage control program disclosed in this specification will be described in detail based on the drawings. However, the embodiment does not limit the disclosed technology.

### Embodiment

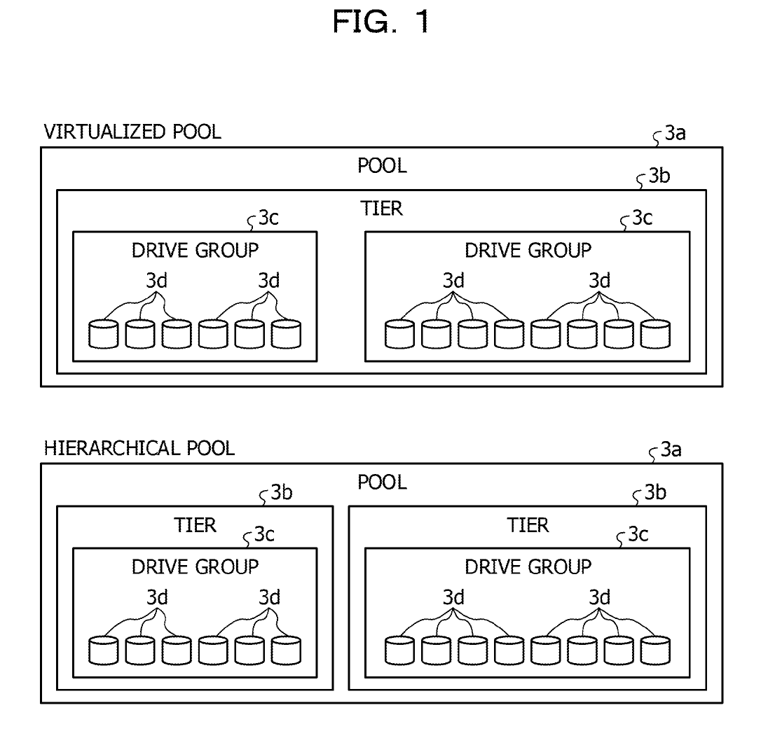

First, a data management method of a storage apparatus according to the embodiment will be described using FIGS. 1 to 7. FIG. 1 is a diagram illustrating a storage configuration of a storage apparatus according to the embodiment. As illustrated in FIG. 1, the storage apparatus according to the embodiment manages multiple SSDs 3d as a pool 3a based on redundant arrays of inexpensive disks (RAID) 6. Also, the storage apparatus according to the embodiment includes multiple pools 3a.

The pool 3a includes a virtualized pool and a hierarchical pool. The virtualized pool include one tier 3b, while the hierarchical pool includes two or more tiers 3b. The tier 3b includes one or more drive groups 3c. The drive group 3c is a group of the SSDs 3d, and includes from 6 to 24 SSDs 3d. For example, among six SSDs 3d that store a single stripe, three are used for data storage, two are used for parity storage, and one is used as a hot spare. Note that the drive group 3c may include 25 or more SSDs 3d.

The storage apparatus according to the embodiment manages data in units of RAID units. The units of physical allocation for thin provisioning are typically chunks of fixed size, in which one chunk corresponds to one RAID unit. In the following description, chunks are called RAID units. A RAID unit is a contiguous 24 MB physical region allocated from the pool 3a. The storage apparatus according to the embodiment buffers data in main memory in units of RAID units, and appends the data to the SSDs 3d.

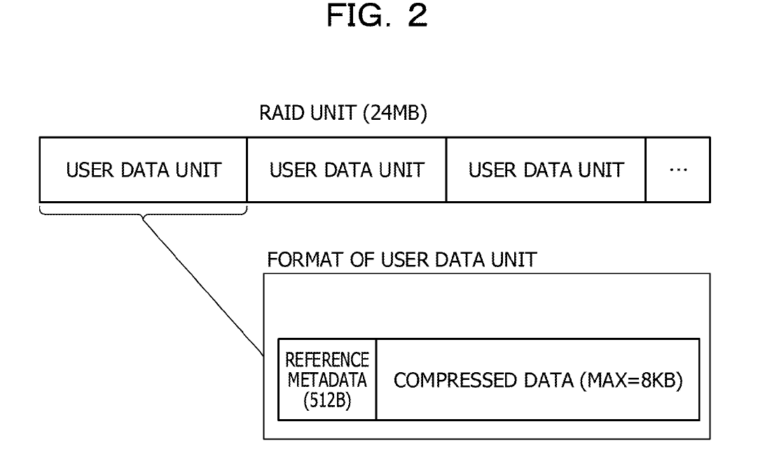

FIG. 2 is a diagram illustrating the format of a RAID unit. As illustrated in FIG. 2, a RAID unit includes multiple user data units (also called data logs). A user data unit includes reference metadata and compressed data. The reference metadata is management data regarding data written to the SSDs 3d.

The compressed data is compressed data written to the SSDs 3d. The maximum size of the data is 8 kilobytes (KB). Assuming a compression rate of 50%, when 24 MB÷4.5 KB÷5461 user data units accumulate, for example, the storage apparatus according to the embodiment writes a RAID unit to the SSDs 3d.

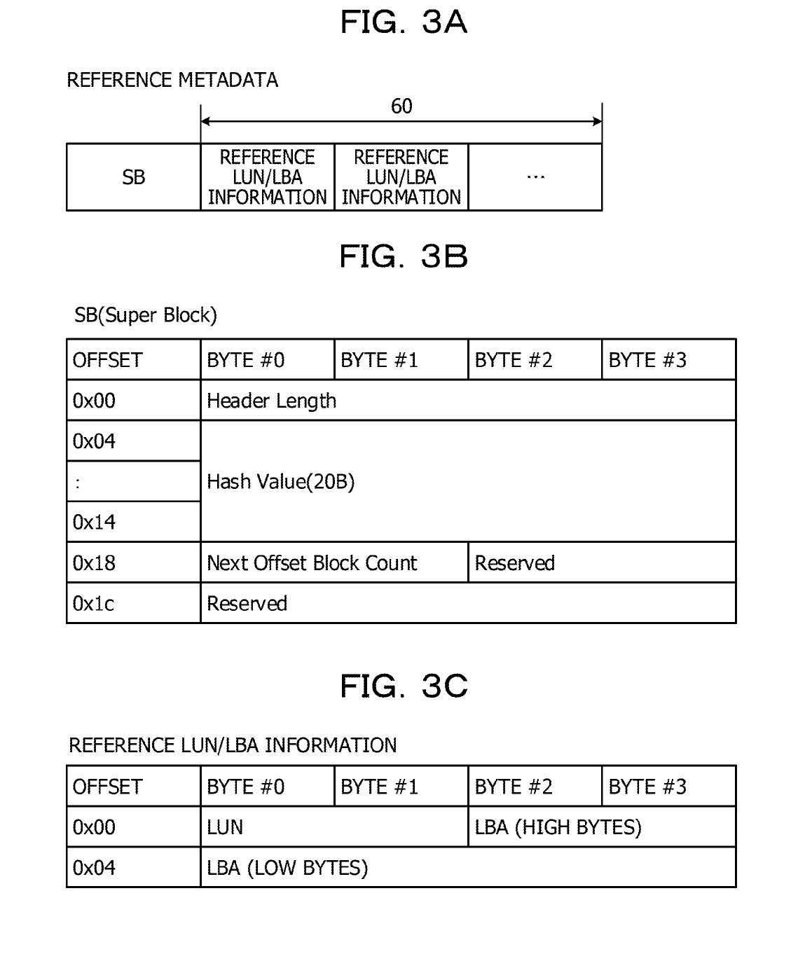

FIG. 3 is a diagram illustrating the format of the reference metadata. As illustrated in FIG. 3A, in the reference metadata, there is reserved a region of storage volume enabling the writing of a super block (SB) and up to 60 referents, namely reference logical unit number (LUN)/logical block address (LBA) information. The size of the SB is 32 bytes (B), and the size of the reference metadata is 512 bytes (B). The size of each piece of reference LUN/LBA information is 8 bytes (B). In the reference metadata, when a new referent is created due to deduplication, the reference is added, and the reference metadata is updated. However, even in the case in which a referent is removed due to the updating of data, the reference LUN/LBA information is retained without being deleted. Reference LUN/LBA information which has become invalid is recovered by garbage collection.

As illustrated in FIG. 3B, the SB includes a 4 B header length field, a 20 B hash value field, and a 2 B next offset block count field. The header length is the length of the reference metadata. The hash value is a hash value of the data, and is used for deduplication. The next offset block count is the position of the reference LUN/LBA information stored next. Note that the reserved field is for future expansion.

As illustrated in FIG. 3C, the reference LUN/LBA information includes a 2 B LUN and a 6 B LBA.

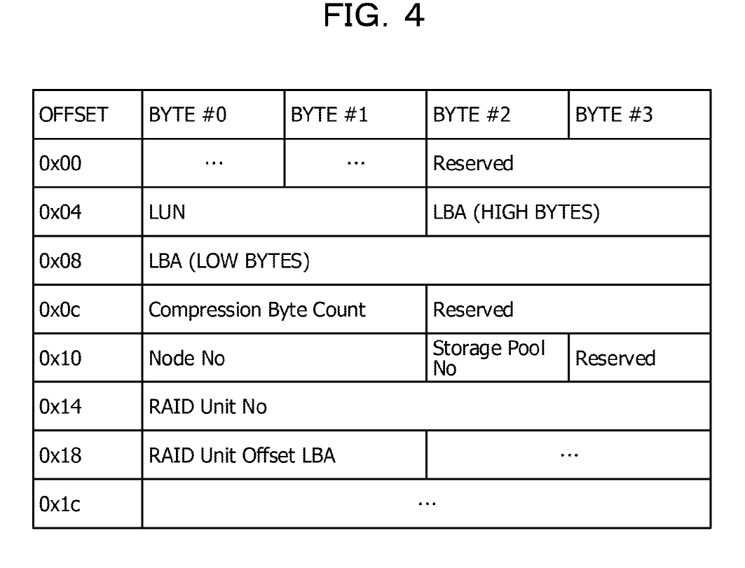

Also, the storage apparatus according to the embodiment uses logical/physical conversion information, namely logical/physical metadata, to manage correspondence relationships between logical addresses and physical addresses. FIG. 4 is a diagram illustrating the format of the logical/physical metadata. The storage apparatus according to the embodiment manages the information illustrated in FIG. 4 for every 8 KB of data.

As illustrated in FIG. 4, the size of the logical/physical metadata is 32 B. The logical/physical metadata includes a 2 B LUN and a 6 B LBA as a logical address of data. Also, the logical/physical metadata includes a 2 B compression byte count field as a byte count of the compressed data.

Also, the logical/physical metadata includes a 2 B node number (no.) field, a 1 B storage pool no. field, a 4 B RAID unit no. field, and a 2 B RAID unit offset LBA field as a physical address.

The node no. is a number for identifying the storage control apparatus in charge of the pool 3a to which the RAID unit storing the data unit belongs. Note that the storage control apparatus will be described later. The storage pool no. is a number for identifying the pool 3a to which the RAID unit storing the data unit belongs. The RAID unit no. is a number for identifying the RAID unit storing the data unit. The RAID unit offset LBA is an address of the data unit within the RAID unit.

The storage apparatus according to the embodiment manages logical/physical metadata in units of RAID units. The storage apparatus according to the embodiment buffers logical/physical metadata in main memory in units of RAID units, and when 786432 entries accumulate in the buffer, for example, the storage apparatus appends and bulk-writes the logical/physical metadata to the SSDs 3d. For this reason, the storage apparatus according to the embodiment manages information indicating the location of the logical/physical metadata by a meta-metadata scheme.

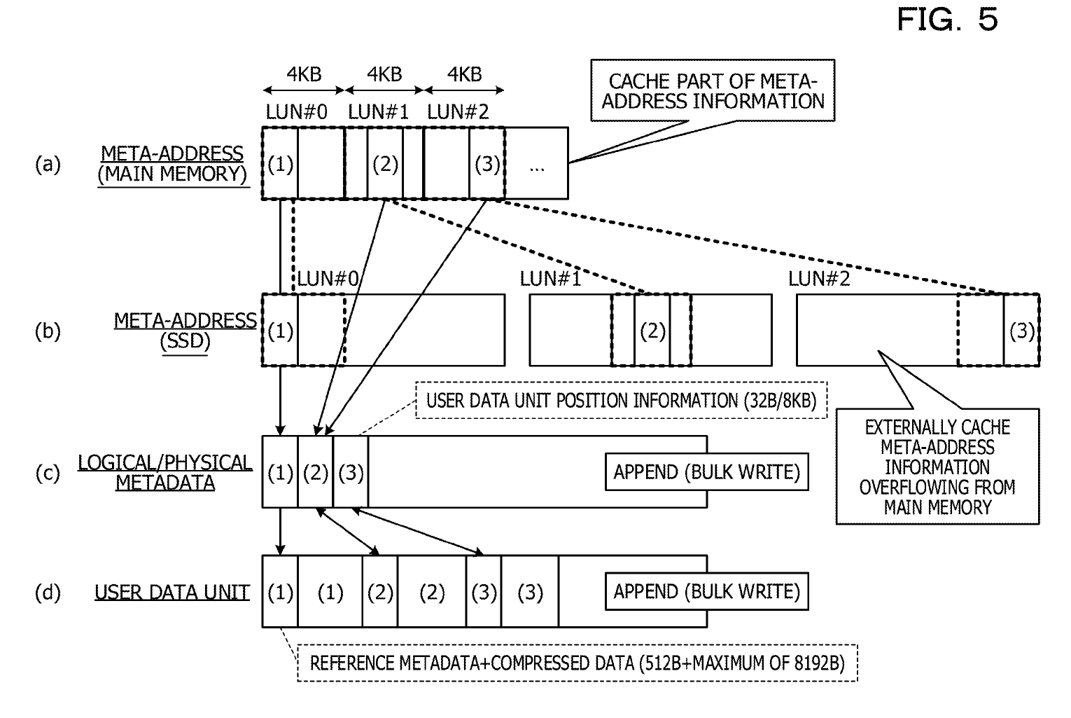

FIG. 5 is a diagram for describing a meta-metadata scheme according to the embodiment. As illustrated in (d) of FIG. 5, the data units labeled (1), (2), (3), and so on are bulk-written to the SSDs 3d in units of RAID units. Additionally, as illustrated in (c) of FIG. 5, logical/physical metadata indicating the positions of the data units are bulk-written to the SSDs 3d in units of RAID units.

In addition, as illustrated in (a) of FIG. 5, the storage apparatus according to the embodiment manages the position of the logical/physical metadata in main memory by using a meta-address for each LUN/LBA. However, as illustrated in (b) of FIG. 5, meta-address information overflowing from the main memory is saved in an external cache (secondary cache). Herein, the external cache refers to a cache on the SSDs 3d.

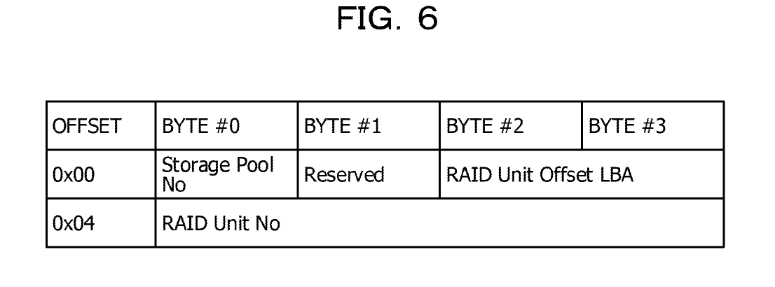

FIG. 6 is a diagram illustrating the format of the meta-address. As illustrated in FIG. 6, the size of the meta-address is 8 B. The meta-address includes a storage pool no., a RAID unit offset LBA, and a RAID unit no. The meta-address is a physical address indicating the storage position of logical/physical metadata on the SSDs 3d.

The storage pool no. is a number for identifying the pool 3a to which the RAID unit storing the logical/physical metadata belongs. The RAID unit offset LBA is an address of the logical/physical metadata within the RAID unit. The RAID unit no. is a number for identifying the RAID unit storing the logical/physical metadata.

512 meta-addresses are managed as a meta-address page (4 KB), and cached in the main memory in units of meta-address pages. Also, the meta-address information is stored in units of RAID units from the beginning of the SSDs 3d, for example.

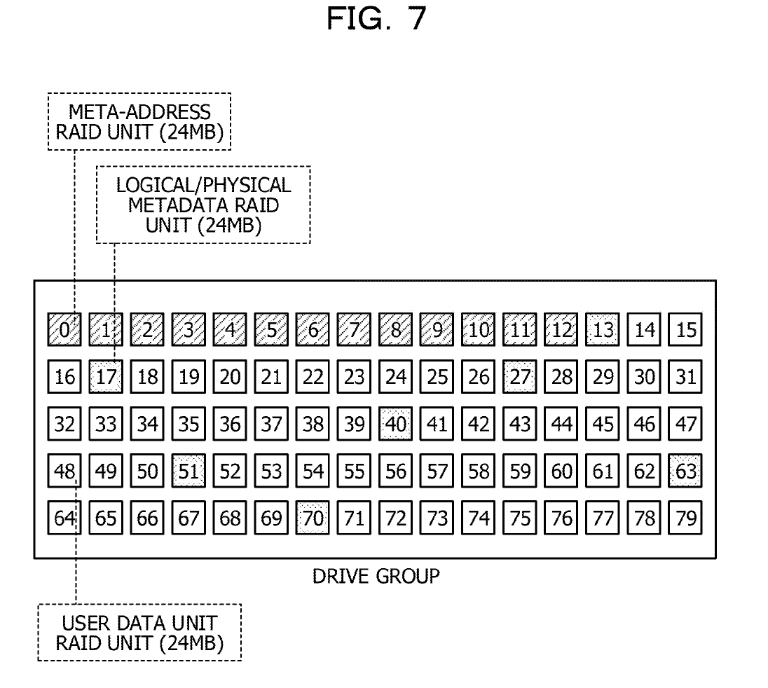

FIG. 7 is a diagram illustrating an exemplary arrangement of RAID units in a drive group 3c. As illustrated in FIG. 7, the RAID units that store meta-addresses are arranged at the beginning. In FIG. 7, the RAID units with numbers from “0” to “12” are the RAID units that store meta-addresses. When there is an meta-address update, the RAID unit storing the meta-address is overwritten and saved.

The RAID units that store the logical/physical metadata and the RAID units that store the user data units are written out sequentially to the drive group when the respective buffer becomes full. In FIG. 7, in the drive group, the RAID units with the numbers “13”, “17”, “27”, “40”, “51”, “63”, and “70” are the RAID units that store the logical/physical metadata, while the other RAID units are the RAID units that store the user data units.

By holding a minimum level of information in main memory by the meta-metadata scheme, and appending and bulk-writing the logical/physical metadata and the data units to the SSDs 3d, the storage apparatus according to the embodiment is able to decrease the number of writes to the SSDs 3d.

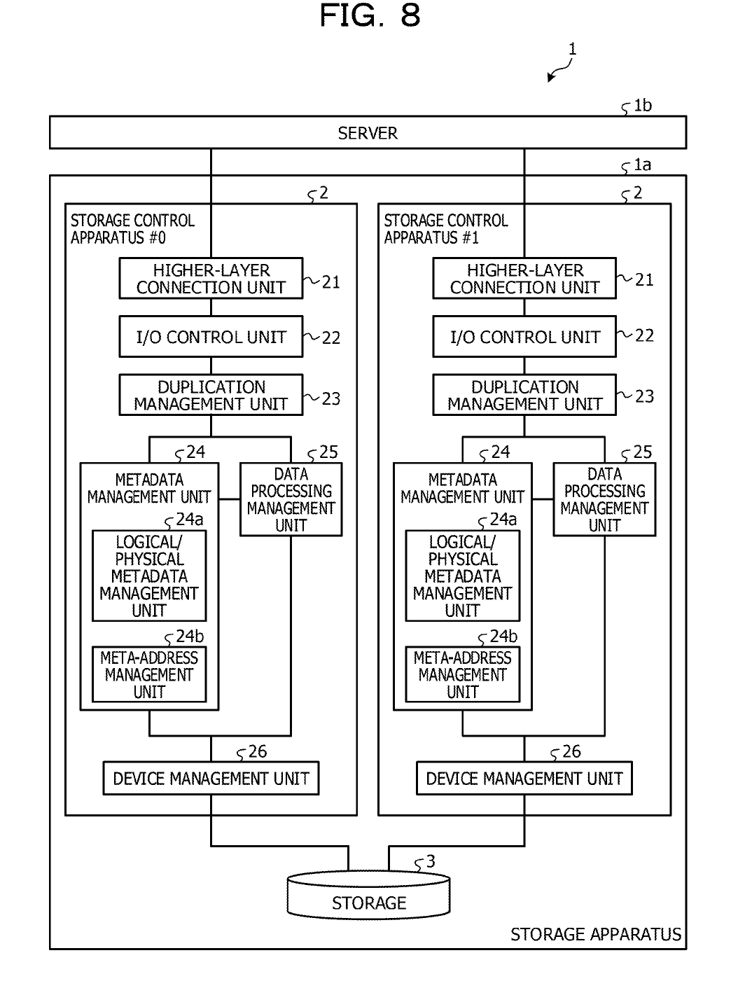

Next, the configuration of the information processing system according to the embodiment will be described. FIG. 8 is a diagram illustrating the configuration of the information processing system according to the embodiment. As illustrated in FIG. 8, the information processing system 1 according to the embodiment includes a storage apparatus 1a and a server 1b. The storage apparatus 1a is an apparatus that stores data used by the server 1b. The server 1b is an information processing apparatus that performs work such as information processing. The storage apparatus 1a and the server 1b are connected by Fibre Channel (FC) and Internet Small Computer System Interface (iSCSI).

The storage apparatus 1a includes storage control apparatus 2 that control the storage apparatus 1a, and storage (a storage device) 3 that stores data. Herein, the storage 3 is a collection of multiple storage apparatus (SSDs) 3d.

Note that in FIG. 8, the storage apparatus 1a includes two storage control apparatus 2 labeled the storage control apparatus #0 and the storage control apparatus #1, but the storage apparatus 1a may include three or more storage control apparatus 2. Also, in FIG. 8, the information processing system 1 includes one server 1b, but the information processing system 1 may include two or more servers 1b.

The storage control apparatus 2 take partial charge of the management of the storage 3, and are in charge of one or more pools 3a. The storage control apparatus 2 include a higher-layer connection unit 21, an I/O control unit 22, a duplication management unit 23, a metadata management unit 24, a data processing management unit 25, and a device management unit 26.

The higher-layer connection unit 21 delivers information between an FC driver and an iSCSI driver, and the I/O control unit 22. The I/O control unit 22 manages data in cache memory. The duplication management unit 23 controls data deduplication/reconstruction to thereby manage unique data stored inside the storage apparatus 1a.

The metadata management unit 24 manages meta-addresses and logical/physical metadata. Also, the metadata management unit 24 uses the meta-addresses and logical/physical metadata to perform a conversion process between logical addresses used to identify data in a virtual volume, and physical addresses indicating the positions where data is stored on the SSDs 3d.

The metadata management unit 24 includes a logical/physical metadata management unit 24a and a meta-address management unit 24b. The logical/physical metadata management unit 24a manages logical/physical metadata related to address conversion information that associates logical addresses and physical addresses. The logical/physical metadata management unit 24a requests the data processing management unit 25 to write logical/physical metadata to the SSDs 3d, and also read out logical/physical metadata from the SSDs 3d. The logical/physical metadata management unit 24a specifies the storage location of logical/physical metadata using a meta-address.

The meta-address management unit 24b manages meta-addresses. The meta-address management unit 24b requests the device management unit 26 to write meta-addresses to the external cache (secondary cache), and also to read out meta-addresses from the external cache.

The data processing management unit 25 manages user data in contiguous user data units, and appends and bulk-writes user data to the SSDs 3d in units of RAID units. Also, the data processing management unit 25 compresses and decompresses data, and generates reference metadata. However, when data is updated, the data processing management unit 25 does not update the reference metadata included in the user data unit corresponding to the old data.

Also, the data processing management unit 25 appends and bulk-writes logical/physical metadata to the SSDs 3d in units of RAID units. In the writing of the logical/physical metadata, 16 entries of logical/physical metadata are appended to one small block (512 B), and thus the data processing management unit 25 manages the logical/physical metadata so that data with the same LUN and LBA does not exist within the same small block.

By managing the logical/physical metadata so that data with the same LUN and LBA does not exist within the same small block, the data processing management unit 25 is able to find the LUN and LBA with the RAID unit number and the LBA within the RAID unit. Note that to distinguish from the 1 MB blocks which are the units of data deletion, herein, the 512 B blocks are called small blocks.

Also, when the readout of logical/physical metadata from the metadata management unit 24 is requested, the data processing management unit 25 responds by searching for the LUN and LBA of the referent from the designated small block in the metadata management unit 24.

The data processing management unit 25 buffers write data in a buffer in main memory, namely a write buffer, and writes out to the SSDs 3d when a fixed threshold value is exceeded. The data processing management unit 25 manages the physical space on the pools 3a, and arranges the RAID units. The device management unit 26 writes RAID units to the storage 3.

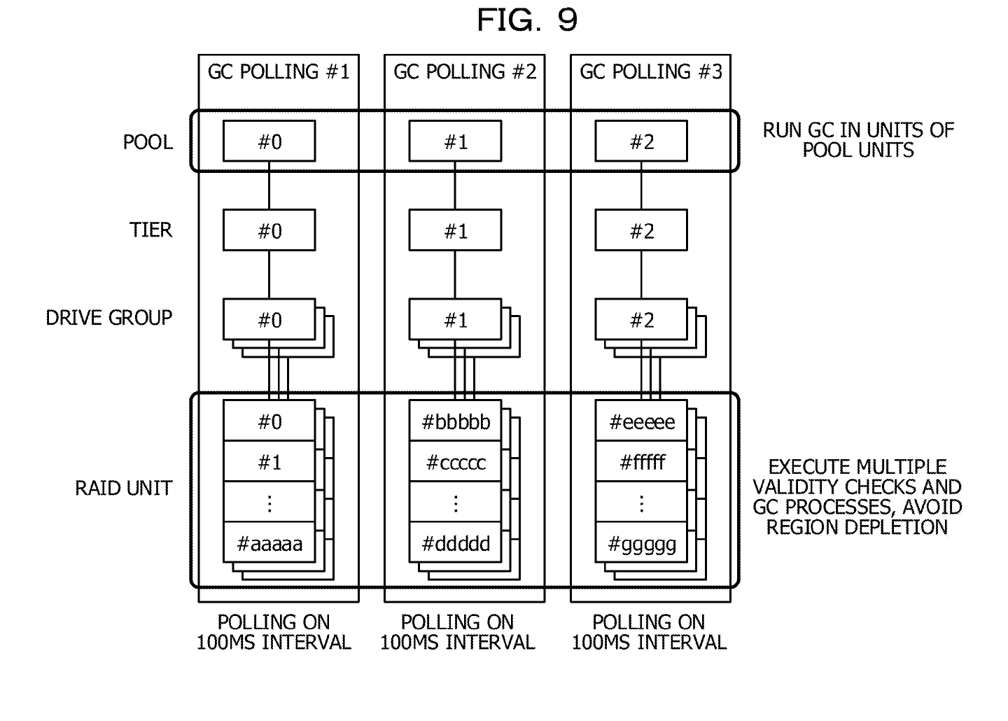

The data processing management unit 25 polls garbage collection (GC) in units of pools 3a. FIG. 9 is a diagram for describing GC polling in units of pools 3a. In FIG. 9, for each of three pools 3a labeled pool #0, pool #1, and pool #2, corresponding GC polling, namely GC polling #1, GC polling #2, and GC polling #3, is performed. Also, in FIG. 9, each pool 3a has a single tier 3b. Each tier 3b includes multiple drive groups 3c, and each drive group 3c includes multiple RAID units.

The data processing management unit 25 performs GC targeting the user data units and the logical/physical metadata. The data processing management unit 25 polls GC for every pool 3a on a 100 ms interval, for example. Also, the data processing management unit 25 generates a thread for each RAID unit to thereby perform GC in parallel with respect to multiple RAID units. The number of generated threads is hereinafter called the multiplicity. The polling interval is decided to minimize the influence of GC on I/O performance. The multiplicity is decided based on a balance between the influence on I/O performance and region depletion.

The data processing management unit 25 reads the data of a RAID unit into a read buffer, checks whether or not the data is valid for every user data unit or logical/physical metadata, appends only the valid data to a write buffer, and then bulk-writes to the storage 3. Herein, valid data refers to data which is in use, whereas invalid data refers to data which is not in use.

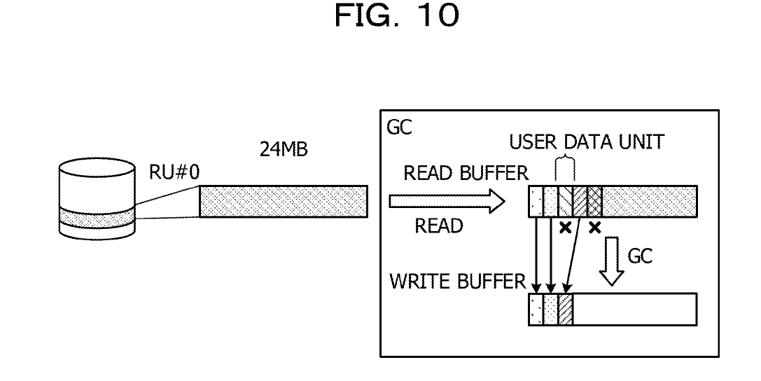

FIG. 10 is a diagram for describing the appending of valid data. In FIG. 10, the RAID unit is a RAID unit used for user data units. As illustrated in FIG. 10, the data processing management unit 25 reads the RAID unit labeled RU#0 into a read buffer, checks whether or not the data is valid for every user data unit, and appends only the valid data to a write buffer.

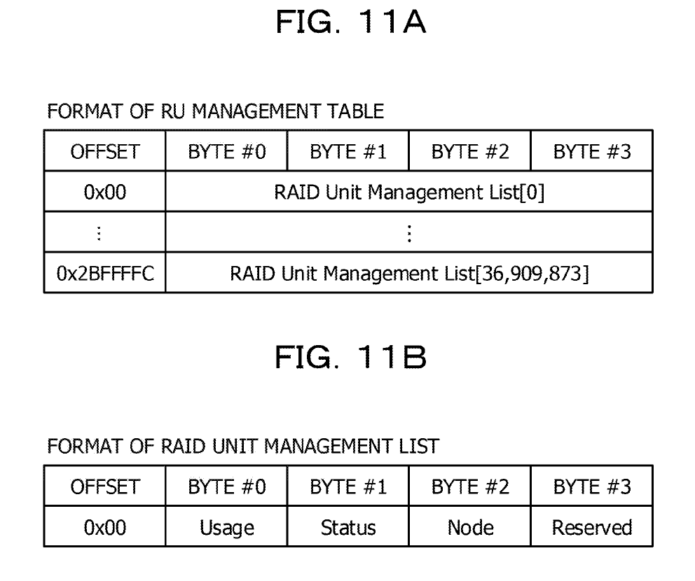

The data processing management unit 25 uses an RU management table to manage whether a RAID unit is used for user data units or for logical/physical metadata. FIG. 11A illustrates the format of the RU management table. As illustrated in FIG. 11A, in the RU management table, information about each RAID unit is managed as a 4 B RAID unit management list.

FIG. 11B illustrates the format of the RAID unit management list. As illustrated in FIG. 11B, the RAID unit management list includes a 1 B usage field, a 1 B status field, and a 1 B node field.

The usage field indicates whether the RAID unit is used for user data units, used for logical/physical metadata, or outside the GC jurisdiction. The default value is “outside GC jurisdiction”, and when the RAID unit is captured for use with user data units, the usage is set to “user data units”, whereas when the RAID unit is captured for use with logical/physical metadata, the usage is set to “logical/physical metadata”. Also, when the RAID unit is released, the usage is set to “outside GC jurisdiction”.

The status field indicates the allocation status of the RAID unit, which may be “unallocated”, “allocated”, “written”, or “GC in progress”. The default value is “unallocated”. “Unallocated” is set when the RAID unit is released. “Allocated” is set when the RAID unit is captured. “Written” is set when writing to the RAID unit. “GC in progress” is set when GC starts.

The node is a number for identifying the storage control apparatus 2 in charge of the RAID unit. The node is set when the RAID unit is captured.

The data processing management unit 25 performs GC on RAID units whose invalid data ratio is equal to or greater than a threshold value (for example, 50%). However, when a duplicate write is performed, that is, when duplicate data is written, only the logical/physical metadata is updated, and thus when there are many duplicate writes, a large amount of invalid data is produced in the logical/physical metadata, but for many of the RAID units used for logical/physical metadata, the invalid data ratio may not exceed the threshold value in some cases.

Accordingly, to perform GC efficiently, the data processing management unit 25 performs GC in a compulsory manner for all RAID units in the pool 3a every time GC polling is performed a predetermined number of times (for example, 5 times), irrespective of the invalid data ratio. However, GC is not performed on a RAID unit having an invalid data ratio of 0, that is, a RAID unit containing data which is all valid.

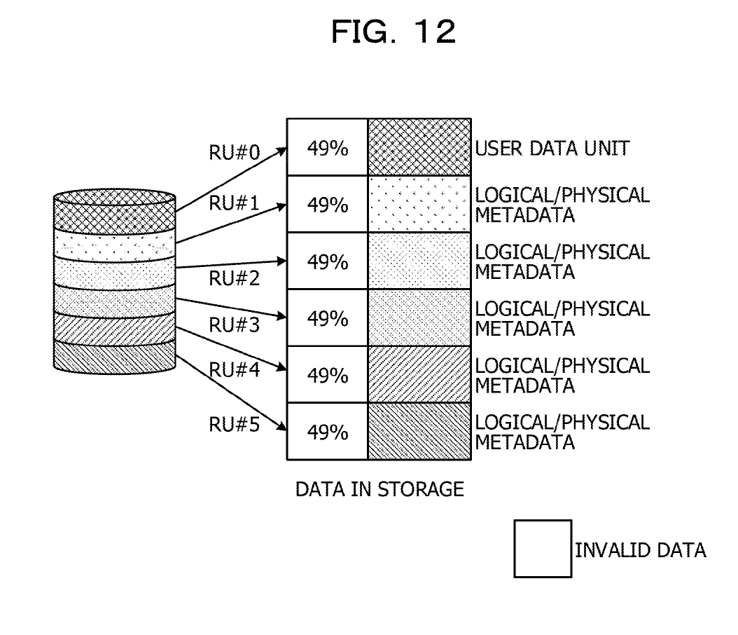

FIG. 12 is a diagram for describing compulsory GC. FIG. 12 illustrates a case in which the invalid data ratio is 49% for one RAID unit used for user data units, and the invalid data ratio is 49% for five RAID units used for logical/physical metadata. In the state illustrated in FIG. 12, GC is not carried out even though nearly half of the data in the six RAID units is invalid data. Accordingly, the data processing management unit 25 performs compulsory GC so that a state like the one illustrated in FIG. 12 does not occur.

The metadata management unit 24 performs exclusive control between I/O to the storage 3 and GC performed by the data processing management unit 25. The reason for this is because if I/O to the storage 3 and GC are executed simultaneously, discrepancies may occur between the meta-address information and the information of the user data units and the logical/physical metadata, and there is a possibility of data loss.

During a write trigger, the metadata management unit 24 acquires an I/O exclusive lock. During a GC trigger, the data processing management unit 25 requests the metadata management unit 24 to acquire an I/O exclusive lock. In the case in which the metadata management unit 24 receives a request to acquire an I/O exclusive lock from the data processing management unit 25, but there is already a write process in progress, the metadata management unit 24 responds to the I/O exclusive lock acquisition request after the write process is completed. The data processing management unit 25 puts GC on standby until the I/O exclusive lock is acquired.

For user data units, the metadata management unit 24 mutually excludes I/O and GC in units of user data units. When GC starts, the data processing management unit 25 requests the metadata management unit 24 to acquire an I/O exclusive lock with respect to all LUNs/LBAs existing in the reference metadata. When GC is completed, the data processing management unit 25 requests the metadata management unit 24 to cancel all acquired I/O exclusive locks.

For logical/physical metadata, the metadata management unit 24 mutually excludes I/O and GC in units of logical/physical metadata. When GC of logical/physical metadata starts, the data processing management unit 25 acquires an I/O exclusive lock with respect to the LUNs/LBAs of the user data units designated by the logical/physical metadata. When GC is completed, the data processing management unit 25 requests the metadata management unit 24 to cancel the acquired I/O exclusive locks.

In the case of a conflict between GC and a duplicate write, the storage control apparatus 2 changes the duplicate write to a new write. Specifically, when GC starts, the data processing management unit 25 sets the status in the RU management table to “GC in progress”. Also, the data processing management unit 25 acquires an I/O exclusive lock with respect to the LUNs/LBAs in the reference metadata of the referent user data units.

Additionally, when a duplicate write to a user data unit targeted for GC occurs, since the LUN/LBA is different from the LUN/LBA in the reference metadata, the duplication management unit 23 does not stand by to acquire an I/O exclusive lock, and instead issues a duplicate write command to the data processing management unit 25. Subsequently, in the case of the duplicate write, the data processing management unit 25 checks the status of the RU management table, and if GC is in progress, responds to the metadata management unit 24 indicating that GC is being executed. Additionally, when the duplication management unit 23 receives the response that GC is being executed from the metadata management unit 24, the duplication management unit 23 clears the hash cache, and issues a new write command.

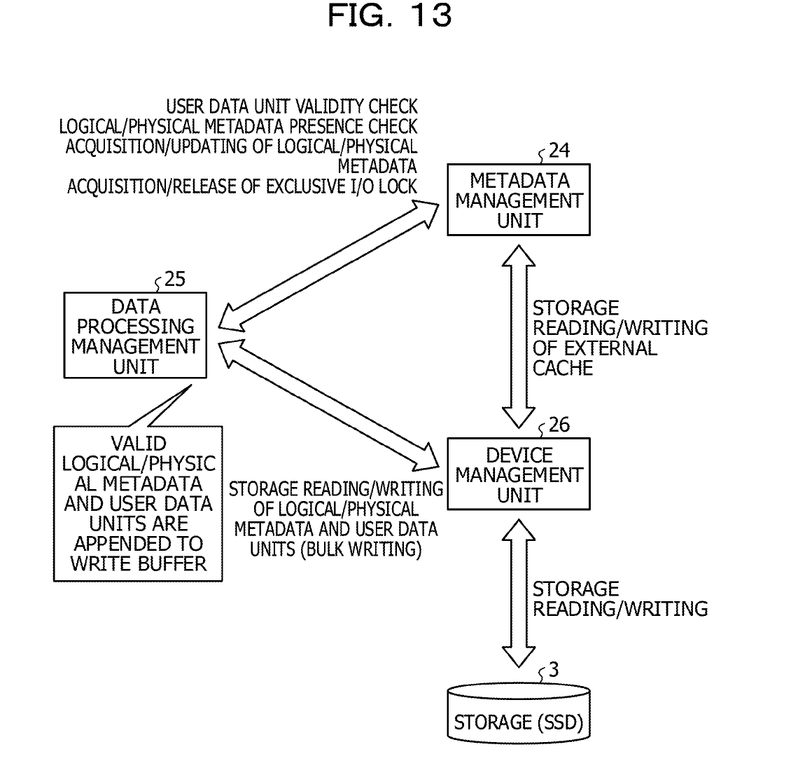

FIG. 13 is a diagram illustrating relationships among functional units. As illustrated in FIG. 13, between the metadata management unit 24 and the data processing management unit 25, user data unit validity checking, logical/physical metadata validity checking, the acquisition and updating of logical/physical metadata, and the acquisition and release of an I/O exclusive lock are performed. Between the data processing management unit 25 and the device management unit 26, storage reads and storage writes of logical/physical metadata and user data units are performed. Between the metadata management unit 24 and the device management unit 26, storage reads and storage writes of the external cache are performed. Between the device management unit 26 and the storage 3, reads and writes of the storage 3 are performed.

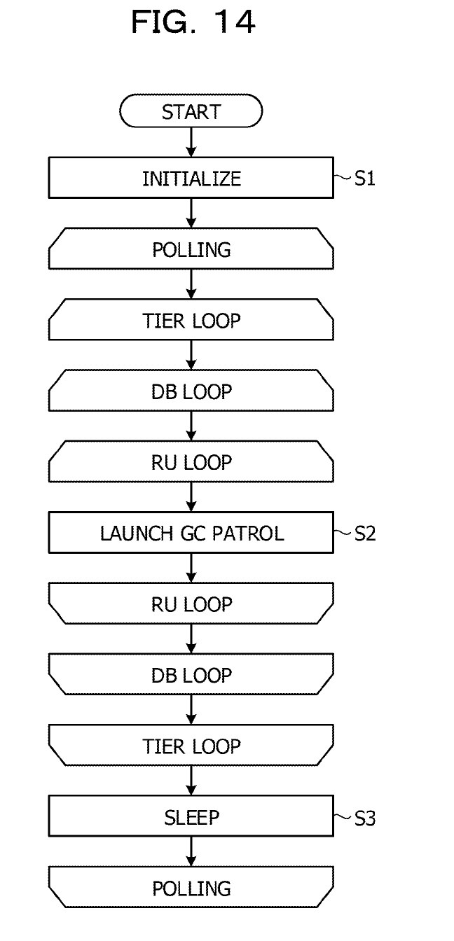

Next, the flow of GC polling will be described. FIG. 14 is a flowchart illustrating the flow of GC polling. As illustrated in FIG. 14, after initialization (step S1), the data processing management unit 25 repeats polling by launching a GC patrol (step S2) for every RAID unit (RU), in every drive group (DG) 3c, in every tier 3b of a single pool 3a.

Regarding RAID units used for user data units, the data processing management unit 25 generates a number of patrol threads equal to the multiplicity, and performs GC processes in parallel. On the other hand, regarding RAID units used for logical/physical metadata, the data processing management unit 25 generates a single patrol thread to perform the GC process. Note that the data processing management unit 25 performs exclusive control so that a patrol thread for a RAID unit used for user data units and a patrol thread for a RAID unit used for logical/physical metadata do not operate at the same time.

Subsequently, when the process is finished for all tiers 3b, the data processing management unit 25 puts GC to sleep so that the polling interval becomes 100 ms (step S3). Note that the process in FIG. 14 is performed on each pool 3a. Also, when the process in FIG. 14 is executed five times, the data processing management unit 25 sets a compulsory GC flag, and compulsory GC is performed.

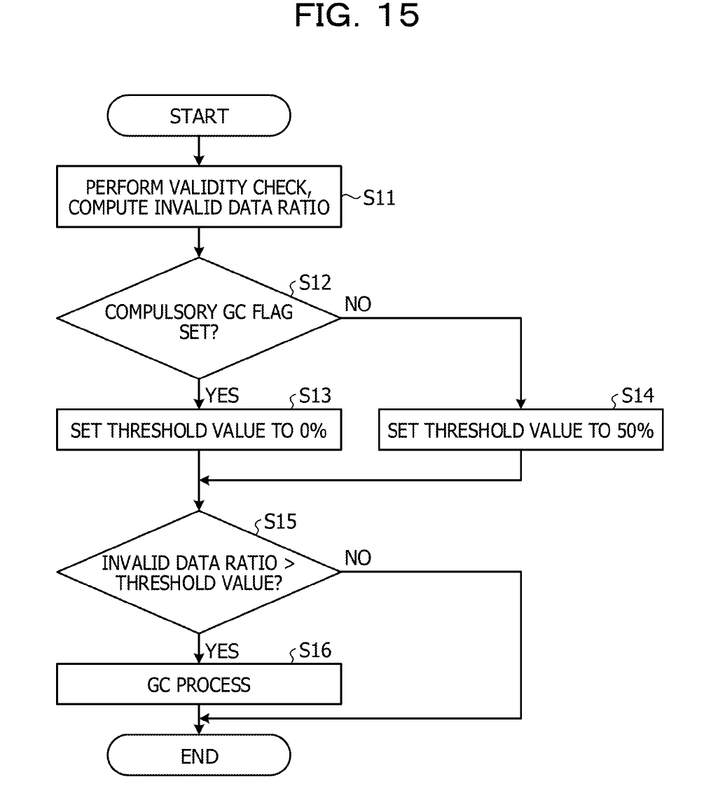

FIG. 15 is a flowchart illustrating the flow of the patrol thread process. As illustrated in FIG. 15, the patrol thread performs a validity check on each user data unit or logical/physical metadata to compute the invalid data ratio (step S11). Subsequently, the patrol thread determines whether or not the compulsory GC flag is set (step S12), and sets the threshold value to 0% (step S13) in the case in which the compulsory GC flag is set, or sets the threshold value to 50% (step S14) in the case in which the compulsory GC flag is not set.

Additionally, the patrol thread determines whether or not the invalid data ratio is greater than the threshold value (step S15), and ends the process in the case in which the invalid data ratio is not greater than the threshold value, or performs the GC process (step S16) in the case in which the invalid data ratio is greater than the threshold value. Herein, the GC process refers to a process such as reading a RAID unit into a read buffer and writing only the valid data to a write buffer.

In this way, by generating a patrol thread for every RAID unit and performing GC, the data processing management unit 25 is able to perform GC efficiently.

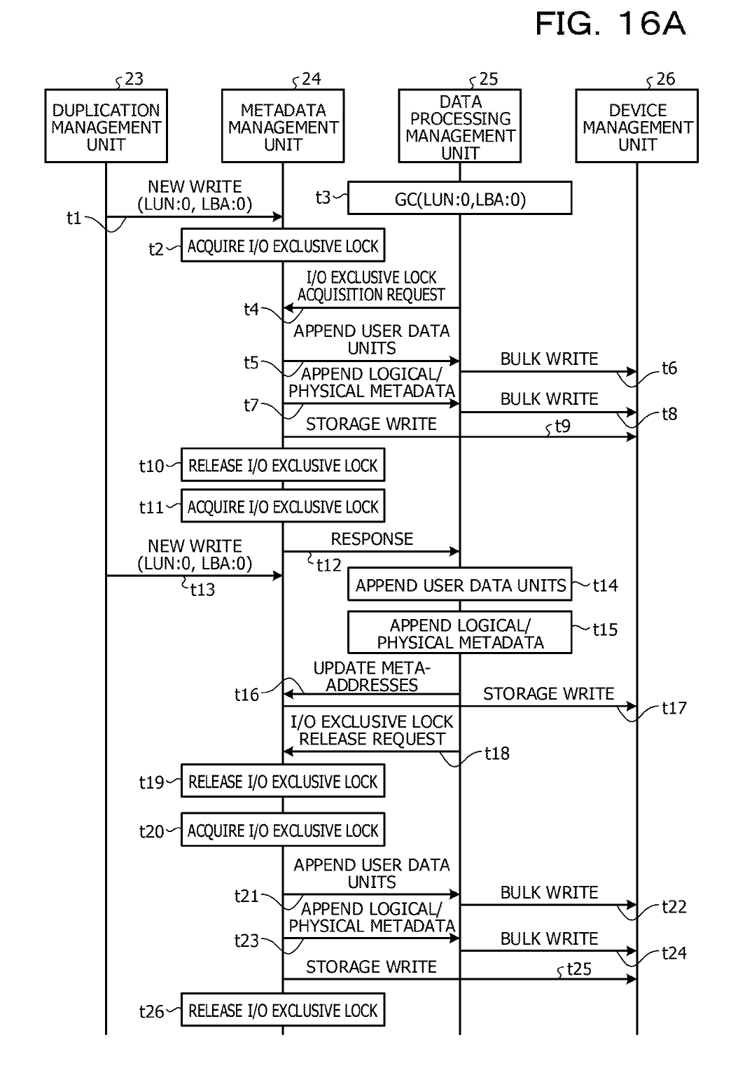

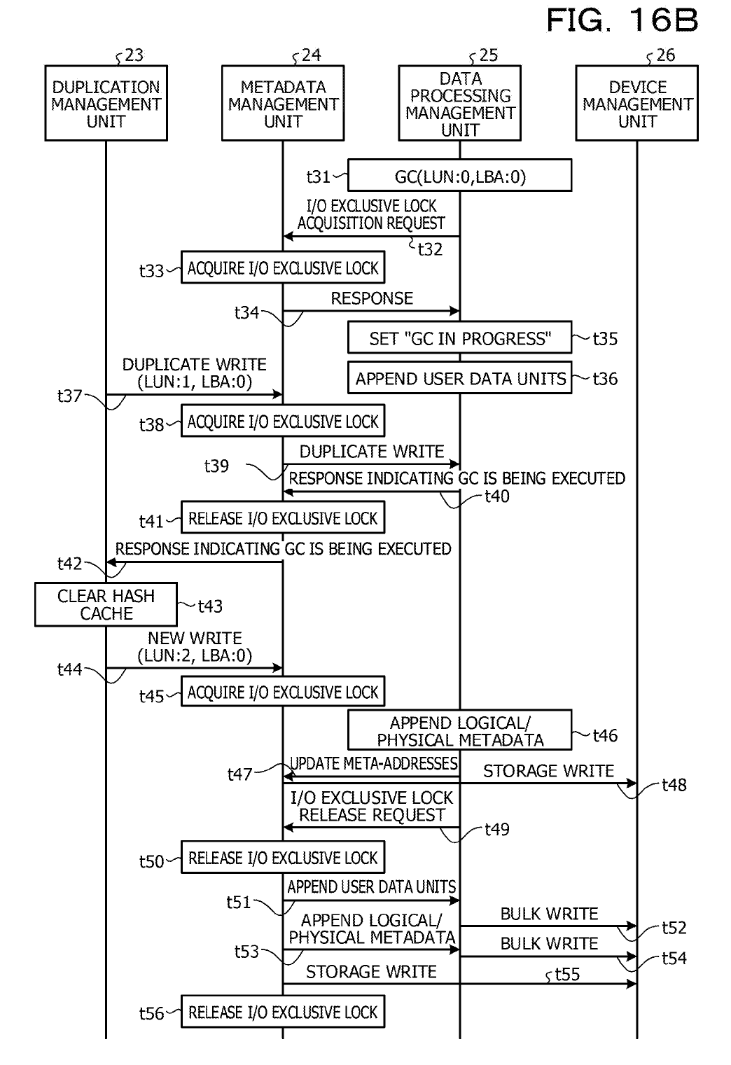

Next, the exclusive control of data writing and GC will be described. FIGS. 16A and 16B are diagrams illustrating a sequence of exclusive control between data writing and GC. FIG. 16A illustrates the case of a new write trigger, while FIG. 16B illustrates the case of a duplicate write by a GC trigger.

As illustrated in FIG. 16A, the duplication management unit 23 requests the metadata management unit 24 for a new write for the region with the LUN “0” and the LBA “0” (step t1), and the metadata management unit 24 acquires an I/O exclusive lock (step t2). Meanwhile, the data processing management unit 25 starts GC of the user data unit storing the data with the LUN “0” and the LBA “0” (step t3), and issues the I/O exclusive lock acquisition request to the metadata management unit 24 (step t4). At this point, the data processing management unit 25 is made to wait until the completion of the new write.

The metadata management unit 24 requests the data processing management unit 25 to append user data units for the new write (step t5), and when the write buffer becomes full, the data processing management unit 25 requests the device management unit 26 to bulk-write the user data units (step t6). Subsequently, the metadata management unit 24 requests the data processing management unit 25 to append logical/physical metadata (step t7), and when the write buffer becomes full, the data processing management unit 25 requests the device management unit 26 to bulk-write the logical/physical metadata (step t8).

Subsequently, the metadata management unit 24 updates the meta-addresses, and requests the device management unit 26 for a storage write (step t9). Subsequently, the metadata management unit 24 releases the I/O exclusive lock (step 10), and acquires an I/O exclusive lock in response to the exclusive lock acquisition request from the data processing management unit 25 (step t11). Subsequently, the metadata management unit 24 responds to the data processing management unit 25 with the acquisition of the I/O exclusive lock (step t12). Subsequently, the duplication management unit 23 requests the metadata management unit 24 for a new write for the region with the LUN “0” and the LBA “0” (step t13).

The data processing management unit 25 appends user data units for the valid data (step t14), and requests the device management unit 26 to bulk-write the write buffer. Subsequently, the data processing management unit 25 appends logical/physical metadata (step t15), and requests the device management unit 26 to bulk-write the write buffer. Subsequently, the data processing management unit 25 requests the metadata management unit 24 to update the meta-addresses (step t16), and the metadata management unit 24 updates the meta-addresses, and requests the device management unit 26 for a storage write (step t17).

Subsequently, the data processing management unit 25 issues an I/O exclusive lock release request to the metadata management unit 24 (step t18), and the metadata management unit 24 releases the I/O exclusive lock (step t19). Subsequently, the metadata management unit 24 acquires an I/O exclusive lock for the write of step t13 (step t20).

Subsequently, the metadata management unit 24 requests the data processing management unit 25 to append user data units (step t21), and when the write buffer becomes full, the data processing management unit 25 requests the device management unit 26 to bulk-write the user data units (step t22). Subsequently, the metadata management unit 24 requests the data processing management unit 25 to append logical/physical metadata (step t23), and when the write buffer becomes full, the data processing management unit 25 requests the device management unit 26 to bulk-write the logical/physical metadata (step t24).

Subsequently, the metadata management unit 24 updates the meta-addresses, and requests the device management unit 26 for a storage write (step t25). Subsequently, the metadata management unit 24 releases the I/O exclusive lock (step t26).

In this way, in the case of a write trigger, the metadata management unit 24 causes the I/O exclusive lock acquisition request from the data processing management unit 25 to wait until the completion of the write, and thereby is able to perform exclusive control of data writing and GC.

Also, as illustrated in FIG. 16B, the data processing management unit 25 starts GC of the user data unit storing the data with the LUN “0” and the LBA “0” (step t31), and issues the I/O exclusive lock acquisition request to the metadata management unit 24 (step t32). Subsequently, the metadata management unit 24 acquires an I/O exclusive lock (step t33), and responds to the data processing management unit 25 with the acquisition of the I/O exclusive lock (step t34). Subsequently, the data processing management unit 25 sets the status in the RU management table to “GC in progress” (step t35). Subsequently, the data processing management unit 25 appends user data units (step t36), and requests the device management unit 26 to bulk-write the write buffer.

At this point, if a duplicate write occurs with respect to the data with the LUN “0” and the LBA “0”, the duplication management unit 23 requests the metadata management unit 24 for a duplicate write of the LUN “1” and the LBA “0” (step t37). Subsequently, since information about the LUN “1” and the LBA “0” is not registered in the reference metadata, the metadata management unit 24 acquires an I/O exclusive lock (step t38), and requests the data processing management unit 25 for a duplicate write (step t39).

Subsequently, the data processing management unit 25 checks the status in the RU management table, responds to the metadata management unit 24 to indicate that GC is being executed (step t40). The metadata management unit 24 releases the I/O exclusive lock (step t41), and responds to the duplication management unit 23 to indicate that GC is being executed (step t42).

Subsequently, the duplication management unit 23 clears the hash cache (step t43), and issues a new write to the metadata management unit 24 for the region with the LUN “2” and the LBA “0” (step t44). Subsequently, the metadata management unit 24 acquires an I/O exclusive lock (step t45).

Meanwhile, the data processing management unit 25 appends logical/physical metadata (step t46), and requests the device management unit 26 to bulk-write the write buffer. Subsequently, the data processing management unit 25 requests the metadata management unit 24 to update the meta-addresses (step t47), and the metadata management unit 24 updates the meta-addresses, and requests the device management unit 26 for a storage write (step t48).

Subsequently, the data processing management unit 25 issues an I/O exclusive lock release request to the metadata management unit 24 (step t49), and the metadata management unit 24 releases the I/O exclusive lock (step t50). Subsequently, the metadata management unit 24 requests the data processing management unit 25 to append user data units for the new write of step t44 (step t51), and when the write buffer becomes full, the data processing management unit 25 requests the device management unit 26 to bulk-write the user data units (step t52). Subsequently, the metadata management unit 24 requests the data processing management unit 25 to append logical/physical metadata (step t53), and when the write buffer becomes full, the data processing management unit 25 requests the device management unit 26 to bulk-write the logical/physical metadata (step t54).

Subsequently, the metadata management unit 24 updates the meta-addresses, and requests the device management unit 26 for a storage write (step t55). Subsequently, the metadata management unit 24 releases the I/O exclusive lock (step t56).

In this way, by changing to a new write when a “GC in progress” response is received with respect to a requested duplicate write, the duplication management unit 23 is able to avoid a conflict between the duplicate write and GC.

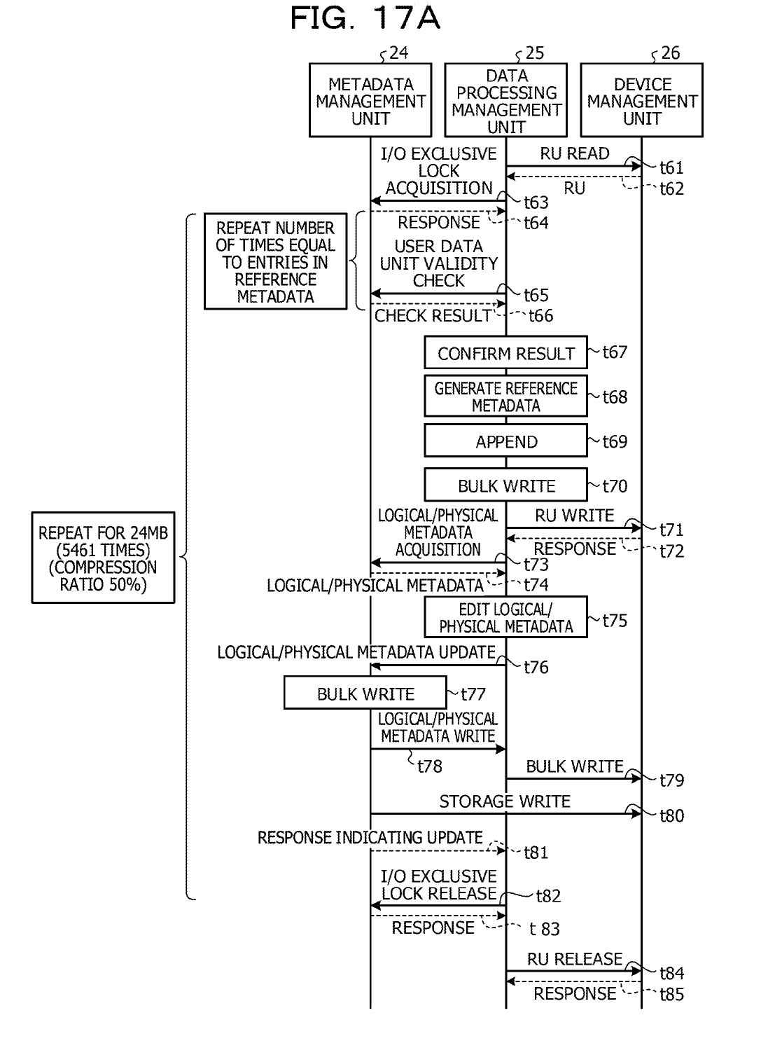

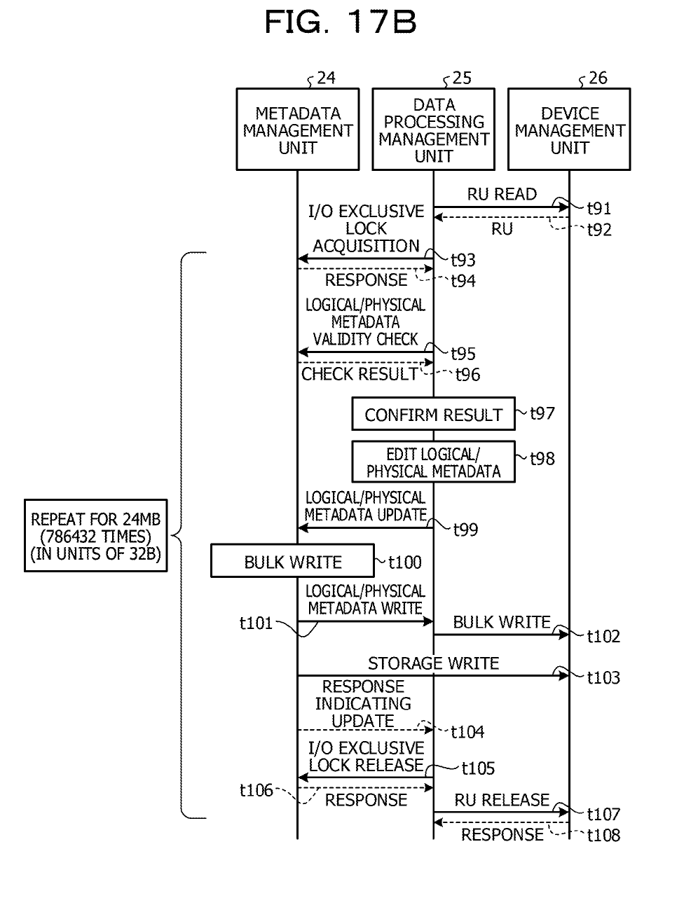

Next, GC sequences will be described. FIG. 17A is a diagram illustrating a sequence of GC of user data units, while FIG. 17B is a diagram illustrating a sequence of GC of logical/physical metadata. As illustrated in FIG. 17A, the data processing management unit 25 requests the device management unit 26 for an RU read (step t61), and receives the RU (step t62).

Subsequently, the data processing management unit 25 requests the metadata management unit 24 for the acquisition of an I/O exclusive lock (step t63), and receives an I/O exclusive lock acquisition response (step t64). Subsequently, the data processing management unit 25 requests the metadata management unit 24 for a validity check of a user data unit (step t65), and receives a check result (step t66). The data processing management unit 25 repeats the request for a validity check of a user data unit a number of times equal to the number of entries in the reference metadata.

Subsequently, the data processing management unit 25 confirms the check result (step t67), and in the case of a valid user data unit, generates reference metadata (step t68), and appends the user data unit (step t69). Subsequently, to bulk-write the user data units (step t70), the data processing management unit 25 requests the device management unit 26 for an RU write (step t71), and receives a response from the device management unit 26 (step t72).

Subsequently, the data processing management unit 25 requests the metadata management unit 24 for the acquisition of logical/physical metadata (step t73), and receives the logical/physical metadata from the metadata management unit 24 (step t74). Subsequently, the data processing management unit 25 edits the logical/physical metadata (step t75), and requests the metadata management unit 24 to update the logical/physical metadata (step t76).

Subsequently, to bulk-write the logical/physical metadata (step t77), the metadata management unit 24 requests the data processing management unit 25 to write the logical/physical metadata (step t78), and when the write buffer becomes full, the data processing management unit 25 requests the device management unit 26 to bulk-write the logical/physical metadata (step t79).

Subsequently, the metadata management unit 24 updates the meta-addresses, and requests the device management unit 26 for a storage write (step t80). Subsequently, the metadata management unit 24 responds to the data processing management unit 25 with the update of the logical/physical metadata (step t81). Subsequently, the data processing management unit 25 requests the metadata management unit 24 for the release of the I/O exclusive lock (step t82), and the metadata management unit 24 responds by releasing the I/O exclusive lock (step t83).

Note that the storage control apparatus 2 performs the process from step t63 to step t83 on all user data units within the RU. Provided that the compression ratio of the data is 50%, the process from step t63 to step t83 is repeated 5461 times.

Subsequently, the data processing management unit 25 requests the device management unit 26 to release the RU (step t84), and receives a response from the device management unit 26 (step t85).

In this way, by performing GC on the RAID units used for user data units, the data processing management unit 25 is able to recover regions used for data which has become invalid. The recovered regions are reused as unallocated regions.

Also, for the logical/physical metadata, as illustrated in FIG. 17B, the data processing management unit 25 requests the device management unit 26 for an RU read (step t91), and receives the RU (step t92). Subsequently, the data processing management unit 25 requests the metadata management unit 24 for the acquisition of an I/O exclusive lock (step t93), and receives an I/O exclusive lock acquisition response (step t94).

Subsequently, the data processing management unit 25 requests the metadata management unit 24 for a validity check of the logical/physical metadata (step t95), receives the check result (step t96), and confirms the check result (step t97). Subsequently, the data processing management unit 25 edits the logical/physical metadata (step t98) so that only the valid information remains, and requests the metadata management unit 24 to update the logical/physical metadata (step t99).

Subsequently, to bulk-write the logical/physical metadata (step t100), the metadata management unit 24 requests the data processing management unit 25 to write the logical/physical metadata (step t101), and when the write buffer becomes full, the data processing management unit 25 requests the device management unit 26 to bulk-write the logical/physical metadata (step t102).

Subsequently, the metadata management unit 24 updates the meta-addresses, and requests the device management unit 26 for a storage write (step t103). Subsequently, the metadata management unit 24 responds to the data processing management unit 25 with the update of the logical/physical metadata (step t104). Subsequently, the data processing management unit 25 requests the metadata management unit 24 for the release of the I/O exclusive lock (step t105), and the metadata management unit 24 responds by releasing the I/O exclusive lock (step t106).

Note that the storage control apparatus 2 performs the process from step t93 to step t106 on all logical/physical metadata within the RU. Since a single entry of logical/physical metadata is 32 B, the process from step t93 to step t106 is repeated 786432 times.

Subsequently, the data processing management unit 25 requests the device management unit 26 to release the RU (step t107), and receives a response from the device management unit 26 (step t108).

In this way, by performing GC on the logical/physical metadata, the data processing management unit 25 is able to recover regions used for logical/physical metadata which has become invalid. The recovered regions are reused as unallocated regions.

As described above, in the embodiment, the logical/physical metadata management unit 24a manages information about logical/physical metadata that associates logical addresses and physical addresses. Additionally, the data processing management unit 25 appends and bulk-writes information about logical/physical metadata to the SSDs 3d in units of RAID units, and also performs GC on the information about logical/physical metadata. Consequently, the storage control apparatus 2 is able to recover regions used for logical/physical metadata which has become invalid.

Also, in the embodiment, the data processing management unit 25 performs GC on every RAID unit for user data units and logical/physical metadata targeted the entire storage 3, and thus is able to recover regions used for user data units and logical/physical metadata which have become invalid from the entire storage 3.

Also, in the embodiment, the data processing management unit 25 performs GC in the case in which the invalid data ratio exceeds 50% for each RAID unit, and when GC is performed five times on a pool 3a, sets a compulsory GC flag to perform GC in a compulsory manner. Consequently, GC may be performed reliably even in cases in which there are many RAID units whose invalid data ratio does not exceed 50%.

Also, in the embodiment, the data processing management unit 25 performs GC on the RAID units used for user data units with a predetermined multiplicity, and thus is able to perform GC efficiently.

Also, in the embodiment, the data processing management unit 25 uses an RU management table to manage whether or not GC is in progress for each RAID unit. Additionally, if the duplication management unit 23 requests a duplicate data write, and receives a response from the data processing management unit 25 indicating that GC is being executed, the duplication management unit 23 changes the duplicate data write to a new data write. Consequently, the duplication management unit 23 is able to avoid a conflict between the duplicate data write and GC.

Note that although the embodiment describes the storage control apparatus 2, by realizing the configuration included in the storage control apparatus 2 with software, it is possible to obtain a storage control program having similar functions. Accordingly, a hardware configuration of the storage control apparatus 2 that executes the storage control program will be described.

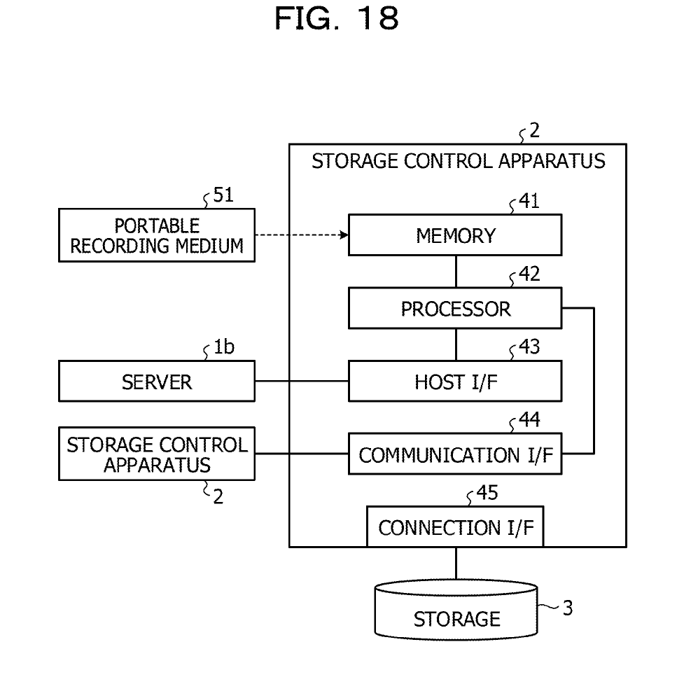

FIG. 18 is a diagram illustrating the hardware configuration of the storage control apparatus 2 that executes the storage control program according to the embodiment. As illustrated in FIG. 18, the storage control apparatus 2 includes memory 41, a processor 42, a host I/F 43, a communication I/F 44, and a connection I/F 45.

The memory 41 is random access memory (RAM) that stores programs, intermediate results obtained during the execution of programs, and the like. The processor 42 is a processing device that reads out and executes programs from the memory 41.

The host I/F 43 is an interface with the server 1b. The communication I/F 44 is an interface for communicating with other storage control apparatus 2. The connection I/F 45 is an interface with the storage 3.

In addition, the storage control program executed in the processor 42 is stored on a portable recording medium 51, and read into the memory 41. Alternatively, the storage control program is stored in databases or the like of a computer system connected through the communication interface 44, read out from these databases, and read into the memory 41.

Also, the embodiment describes a case of using the SSDs 3d as the non-volatile storage media, but the present technology is not limited thereto, and is also similarly applicable to the case of using other non-volatile storage media having device characteristics similar to the SSDs 3d.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control apparatus configured to control a storage device including a storage medium with a limited number of writes, comprising:
a memory; and
a processor coupled to the memory and configured to:
record, to the storage medium, address conversion information associating logical addresses by which an information processing apparatus that uses the storage device identifies data with physical addresses indicating positions where the data is stored on the storage medium, and
execute garbage collection of the storage medium based on the recorded address conversion information.

2. The storage control apparatus according to claim 1, wherein
the processor
appends and bulk-writes the address conversion information and data to the storage medium, and
executes garbage collection on all of the address conversion information and the data per a storage unit of bulk writing.

3. The storage control apparatus according to claim 2, wherein
the processor
executes garbage collection when an invalid data ratio for each storage unit exceeds a threshold value, and
when garbage collection is executed a predetermined number of times on a pool, the pool being a region of fixed size on the storage medium, the processor sets the threshold value to 0 to execute garbage collection in a compulsory manner.

4. The storage control apparatus according to claim 2, wherein
the processor executes plural instances of garbage collection in parallel on each storage unit in which data is bulk-written.

5. The storage control apparatus according to claim 2, wherein
the processor
manages whether or not garbage collection is being executed for each storage unit,
performs data duplication management, and
when a response is received with respect to a duplicate data write instruction, the response indicating that garbage collection is being executed, the processor changes the duplicate data write to a new data write.

6. A storage control method configured to control a storage device including a storage medium with a limited number of writes, comprising:
recording, to the storage medium, address conversion information associating logical addresses by which an information processing apparatus that uses the storage device identifies data with physical addresses indicating positions where the data is stored on the storage medium; and
executing garbage collection of the storage medium based on the recorded address conversion information.
